(19) United States
(12) Patent Application Publication
(10) Pub. No.: US 2026/0288150 A1
(43) Pub. Date: Sep. 24, 2026

(54) ROBOT CONTROL SYSTEM AND ROBOT CONTROL METHOD

(71) Applicant: TOYOTA JIDOSHA KABUSHIKI KAISHA, Toyota-shi (JP)

(72) Inventors: Yoshiki UEDA, Nagakute-shi (JP); Osamu TANIAI, Okazaki-shi (JP); Shiro ODA, Anjo-shi (JP)

(73) Assignee: TOYOTA JIDOSHA KABUSHIKI KAISHA, Toyota-shi (JP)

(21) Appl. No.: 19/432,647

(22) Filed: Dec. 24, 2025

(30) Foreign Application Priority Data
Mar. 24, 2025 (JP) 2025-047999

(51) Int. Cl. G05D 1/622

(52) U.S. Cl. CPC G05D 1/622

(57) ABSTRACT

A robot control system according to the present disclosure sets a plurality of waypoints serving as candidates for a via point of an autonomous movement robot on a map, sets a passage classification of the robot for each of the waypoints, searches for a route to a destination based on the plurality of waypoints, controls the autonomous movement robot such that the robot sequentially passes through the waypoints to the destination according to the passage classification, captures an image of an environment in which the autonomous movement robot moves by using a camera, and changes the passage classification based on a captured result of the camera. An AI model generated by machine learning such as supervised learning may be used for route planning, waypoint setting, or area setting.

### CROSS-REFERENCE TO RELATED APPLICATION

This application claims priority to Japanese Patent Application No. 2025-047999 filed on Mar. 24, 2025. The disclosure of the above-identified application, including the specification, drawings, and claims, is incorporated by reference herein in its entirety.

### BACKGROUND

### 1. Technical Field

The present disclosure relates to a robot control system and a robot control method.

### 2. Description of Related Art

Japanese Unexamined Patent Application Publication No. 2024-3200 (JP 2024-3200 A) discloses an information processing device that manages a group of robots that are movable. The information processing device acquires a map in which a passable region and an impassable region for the robots that are movable are distinguished, and information on sizes of the robots. The information processing device divides the passable region on the map into a first region in which an autonomous driving direction of the robots is determined and a second region in which the autonomous driving direction of the robots is not determined. Information indicating whether the robots can pass each other is generated using the information on the sizes of the robots.

### SUMMARY

In such a device of a moving object, there is a demand for controlling a robot such that the robots can move efficiently.

A robot control system according to the present disclosure is a robot control system that controls an autonomous movement robot, in which the robot control system is configured to set, on a map, a plurality of waypoints serving as candidates for via points of the autonomous movement robot,

set a passage classification of the autonomous movement robot to each of the waypoints,

search for a route to a destination based on the waypoints,

control the autonomous movement robot such that the autonomous movement robot sequentially passes through the waypoints to the destination in accordance with the passage classification,

capture, an image of an environment in which the autonomous movement robot moves using a camera, and

change the passage classification based on a captured result of the camera.

A robot control method according to the present disclosure is a robot control method that controls a plurality of kinds of autonomous movement robots, the robot control method including:

setting, on a map, a plurality of waypoints serving as candidates for via points of the autonomous movement robots;

setting a passage classification of the autonomous movement robots to each of the waypoints;

searching for a route to a destination based on the waypoints;

controlling the autonomous movement robots such that the autonomous movement robots sequentially pass through the waypoints to the destination in accordance with the passage classification;

capturing an image of an environment in which the autonomous movement robots move using a camera; and

changing the passage classification based on a captured result of the camera.

According to the present disclosure, it is possible to provide the robot control system and the robot control method that can control the robots to move efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an overall configuration of a control system according to the present embodiment;

FIG. 2 is a block diagram showing a control system of a control device;

FIG. 3 is a diagram illustrating a restricted area and a waypoint set in map information of a facility;

FIG. 4 is a flowchart showing a control method according to the present embodiment; and

FIG. 5 is a table showing a correspondence between an attribute of a waypoint and an action.

### DETAILED DESCRIPTION OF EMBODIMENTS

Hereinafter, the present disclosure will be described with an embodiment of the present disclosure, but the disclosure according to the claims is not limited to the following embodiment. Moreover, not all of the configurations described in the embodiments are indispensable as means for solving the problem.

### Overall Configuration

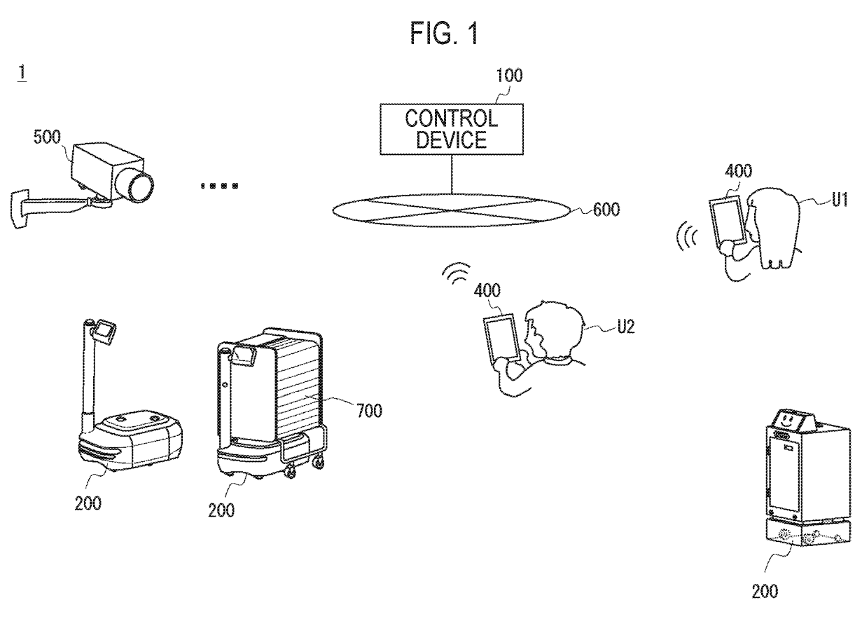

The control system according to the present embodiment is a system for managing an autonomous moving object. FIG. 1 is a schematic diagram showing a configuration of a control system 1. The control system 1 includes a control device 100, a robot 200, a camera 500, a network 600, a user terminal 400, and an accessory unit 700. The control system 1 is a system for managing a plurality of robots 200. The control device 100 manages passage and a task of the plurality of robots 200.

The robot 200 is an autonomous moving object that executes a task such as a transport task. The robot 200 autonomously moves in a medical and welfare facility such as a hospital, a rehabilitation center, a care facility, and a senior living facility. The robot 200 is used for transporting medicines, medical devices, meals, tableware, medical records, supplies, specimens, linens, people, and the like. The transport target may be a person such as a patient. In addition, the system according to the present embodiment can also be used in a commercial facility or the like, such as a shopping mall. The robot 200 includes wheels, a vehicle frame, a motor, a sensor, a battery, a controller, and the like.

The robot 200 is equipped with a distance measurement sensor such as LiDAR. The distance measurement sensor measures a distance to a peripheral object such as an object or a person around the robot 200. The robot 200 performs autonomous driving without coming into contact with the peripheral object around the robot 200. For example, the robot 200 has a virtual bumper function. In the virtual bumper function, in a case where the peripheral object approaches the robot 200 by a predetermined distance or less, the robot 200 decelerates or stops.

At least one of the robots 200 is a robot of a different type. All of the robots 200 may be the same type of robot. Each of the robots 200 is assigned a unique identification number (ID). In FIG. 1, three robots 200 are shown, but the number of robots is not particularly limited as long as it is plural.

Further, at least one of the robots 200 may execute a task other than the transport task. Examples of the other tasks include a cleaning task, a security task, and a guidance task. The robot 200 may execute a plurality of tasks such as cleaning, security, and guidance using the accessory unit 700, or may execute a task alone. The robot 200 executes various tasks, for example, by using the accessory unit 700 in combination with the robot 200. Different accessory units may be prepared for the robot 200 depending on the task. By replacing the accessory unit 700, the robot 200 becomes a multitask robot that executes a plurality of tasks.

In a case of the transport task, the accessory unit 700 is a cart or a wagon with wheels on which a transport object is mounted. In a case of the cleaning task, the accessory unit 700 includes a vacuum cleaner that sucks up garbage and the like. In a case of the security task, the accessory unit 700 includes a sensor such as a light detection and ranging (LiDAR) or a camera. In a case of the guidance task, the accessory unit 700 includes a signboard or a display. In the following description, the robot 200 will be mainly described as executing the transport task.

The user U1 or the user U2 can make a task request such as a transport request of the transport object using the user terminal 400. For example, the user terminal 400 is a tablet computer or a smartphone. The user terminal 400 may be an information processing device capable of wireless or wired communication.

In the present embodiment, the robot 200 and the user terminal 400 are connected to the control device 100 via the network 600. The network 600 is a wired or wireless local area network (LAN) or wide area network (WAN). Further, the control device 100 is connected to the network 600 in a wired or wireless manner. For communication between the devices, for example, a general communication standard such as Wi-Fi (registered trademark) can be used.

Various signals transmitted from the user terminals 400 of the users U1, U2 are temporarily sent to the control device 100 via the network 600, and are transmitted from the control device 100 to the target robot 200. Similarly, various signals transmitted from the robot 200 are temporarily sent to the control device 100 via the network 600, and are transmitted from the control device 100 to the target user terminal 400. The control device 100 is a server connected to each device, and collects data from each device. In addition, the control device 100 is not limited to a single physical device, and may have a plurality of devices that perform distributed processing. In addition, the control device 100 may be disposed in a distributed manner in an edge device such as the robot 200. For example, a part or all of the control system 1 may be mounted on the robot 200.

The robot 200 includes a drive motor, wheels, a battery, and the like. Further, the robot 200 includes a sensor such as a camera or LiDAR, and a calculation processing unit such as a processor. The robot 200 estimates a self-position based on a detection result of the sensor. The robot 200 autonomously moves on a route from a departure point to a destination on the map based on the self-position. The departure point is a current position of the robot, and the destination is a transport destination of the transport object. In addition, the route search may be performed via a transport source of the transport object or the like as a via point. The control device 100 may perform the route search from the departure point to the destination, or the robot 200 may perform the route search.

The user terminal 400 and the robot 200 may transmit and receive signals without passing through the control device 100. For example, the user terminal 400 and the robot 200 may directly transmit and receive signals by wireless communication. In addition, the control device 100 may collect data from the camera 500. The camera 500 is a surveillance camera, a security camera, or the like. Further, the control device 100 may collect data from a communication device or a sensor (not shown).

It is assumed that a plurality of types of robots 200 is used in the facility. The control device 100 assigns a task to each robot 200. Each robot 200 may execute the assigned task by mounting the accessory unit 700 corresponding to the assigned task. The task executed by the robot 200 may be input by the user U1 or the user U2, or may be scheduled in advance. For example, the user U1 or the like performs the task request by operating the user terminal 400. The user U1 or the like can input a type of the task to be executed. The user U1 or the like may input a region or a time slot in which the task is executed. The control device 100 creates a schedule for the robot 200 to efficiently execute the task.

The user U1 or the user U2 may request the transport task by operating the user terminal 400. In this case, the user U1 or the user U2 inputs information related to the transport object. Further, the user U1 or the user U2 may input scheduled arrival information indicating an arrival schedule of the transport object. The control device 100 assigns the robot that executes the transport task based on the scheduled arrival information. Then, the control device 100 transmits a control signal for the robot to execute the task. The control signal may include route information to the destination or transport object information indicating the transport object or the like.

In such an overall configuration, each element of the control system 1 can be distributed to the robot 200, the user terminal 400, and the control device 100 to construct the control system 1 as a whole. In addition, a substantial element for realizing the transport of the transport object can be collected in one device to be constructed.

### Control System

The control device 100 includes a server computer or the like, and performs calculation for controlling and managing the robot 200. The control device 100 can be implemented as, for example, a device capable of executing a program, such as a central processing unit (CPU) of a computer. The functions described below can also be realized by a program. The control device 100 manages the transported object and the robot 200 based on the transport object ID of the transport object and the robot ID of the robot 200, respectively.

For example, the control device 100 manages the schedules of the plurality of robots 200 such that the robots 200 can efficiently execute the task. For example, in a case where the control device 100 receives the task request from the user terminal 400 or the like, the control device 100 selects one robot 200 from the plurality of robots 200 and issues an instruction to the robot 200 to execute the task. Alternatively, the control device 100 instructs the robot 200 regarding which accessory unit 700 to use.

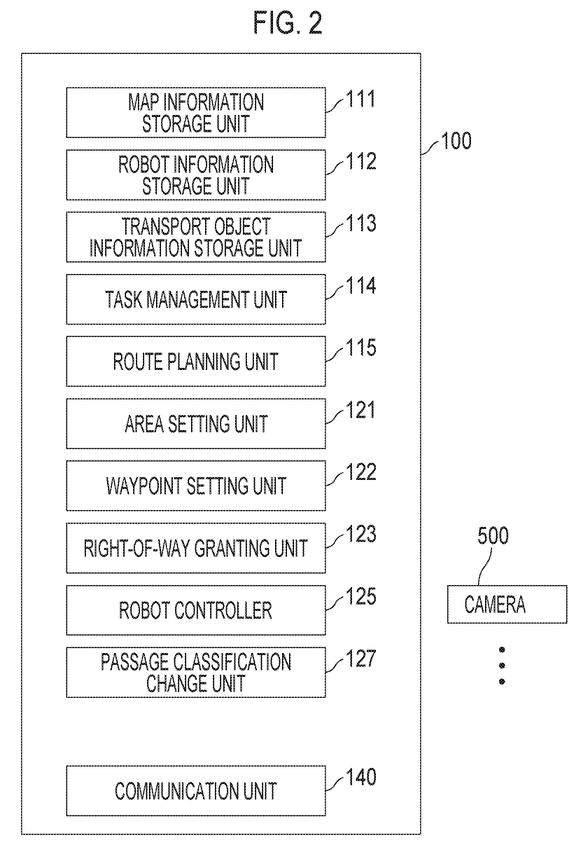

FIG. 2 is a block diagram showing a control system of the control device 100 according to the present embodiment. As shown in FIG. 2, the control device 100 includes a map information storage unit 111, a robot information storage unit 112, a transport object information storage unit 113, a task management unit 114, and a route planning unit 115. In addition, the control device 100 includes an area setting unit 121, a waypoint setting unit 122, a robot controller 125, and a communication unit 140. In addition, the control device 100 includes a right-of-way granting unit 123 and a passage classification change unit 127. The functional blocks shown in FIG. 2 are examples, and the control device 100 may include other functional blocks. Alternatively, the control device 100 may not include a part of the functional blocks shown in FIG. 2. Further, some functions may be performed on the robot 200 side. The control device 100 acquires image information from one or a plurality of cameras 500. The image information may include image data. The image information may include information extracted from the image data.

The map information storage unit 111 stores map information indicating a floor map (simply referred to as a map) of the facility. The map information may include information on a restricted area, a waypoint, and the like that will be described below. The map information may be created in advance. In addition, the map information may be map information including a partial region in which a service is scheduled to be executed, instead of a floor map of the entire facility. Each robot performs autonomous driving to the destination by referring to the map information. The map information may be generated based on an architectural drawing, computer-aided design (CAD) data, building information modeling (BIM) data, or the like. Alternatively, the map information may be generated based on a measurement result of a distance measurement sensor such as LiDAR.

The robot information storage unit 112 stores robot information. The robot information includes information on the robot 200 that is operating in the facility. The robot information includes information on a model number of the robot 200, a service that can be executed, a transport object type that can be transported, an accessory unit 700 that can be mounted, and the like. The robot information storage unit 112 stores the robot information in a database in which various types of information and the like are stored for each robot ID. The robot information may include a current position of the robot, a movement route, information indicating whether the robot is executing a task or is on a break, and information on the task being executed. The robot information may include information on an accessory unit in use or a transport object in transport.

The transport object information storage unit 113 stores transport object information related to the transport object. For example, the transport object information includes information such as an identification number (ID) of the transport object, a content (type) of the transport object, a transport source, a transport destination, a reception time, or an arrival time. The transport object information 126 is information indicating whether the transport object is a medicine, a medical device, a meal, tableware, a medical record, a supply, a specimen, a linen, a person, or the like. The transport object information may include information such as a size or a weight of the transport object. The transport object information may include information indicating a status such as in transport, before transport (before mounting), and after transport. The transport object information storage unit 113 stores the transport object information in a database in which these pieces of information are associated with each other for each transport object ID. In a case where a new transport request of the transport object is received from the user terminal 400, the transport object information is added. In addition, after the transport is completed, the information related to the transport object may be deleted from the list.

The task management unit 114 manages the task executed by the robot 200. For example, the user U1 inputs the transport object information indicating the transport object, the transport source, the transport destination, and the like to request the transport task. The task management unit 114 assigns the transport task to the robot 200. For example, the task management unit 114 extracts the robot that can execute the task. For example, in a case where some of the robots 200 cannot transport the transport object requested for transport, the task management unit 114 extracts the robot 200 by excluding the robot 200.

The task management unit 114 extracts the robot 200 that can transport the transport object from among the plurality of robots 200. Then, the task management unit 114 assigns the transport task to the extracted robot 200. In a case where there are two or more robots that can transport the transport object, the task management unit 114 selects the robot such that the transport service can be executed more efficiently. For example, the task management unit 114 assigns the task to the robot that is near the transport source. Alternatively, the task management unit 114 assigns the task to the robot in an idle state in which another task is not being executed. In this way, the task can be efficiently executed.

The task management unit 114 manages the task executed, the task being executed, and the task scheduled to be executed by each robot 200. Further, the task management unit 114 may store various types of task information for each task in a database. The task management unit 114 may store information indicating whether each robot 200 is executing or has completed the task, as the task information. In addition, the task management unit 114 may store a transport start time at which the transport is started or a completion scheduled time at which the task being executed is completed, as the task information. The transport information related to the transport object in transport may be included in the task information. For example, the task information may include information such as a type of the transport object, a transport destination, and a transport source. Alternatively, the task management unit 114 may store information indicating whether the accessory unit 700 is in use.

The route planning unit 115 plans a route for executing the task. For example, the route planning unit 115 searches for a route from the transport source to the transport destination of the robot 200 to which the task is assigned. Specifically, a route from the current position of the robot 200 to the transport source is searched for. The transport source is a mounting place where the transport object is mounted. Further, the route planning unit 115 searches for a route from the transport source to the transport destination.

Waypoints set on the map are used for the route search. The waypoints are set on the map as candidates for the via points through which the robot passes. The waypoints will be described below. The route searched for by the route planning unit 115 is transmitted to the robot 200. At least a part of the processing of the route planning unit 115 may be executed by the robot 200. Further, in a case where a congested region is specified based on an image by a surveillance camera or the like, the route planning unit 115 may search for a route to avoid the congested region. The route planning unit 115 may search for a route that enables movement in the shortest time, the shortest distance, or the like.

In a case where the waypoints corresponding to the departure point, the destination, and the via point are input, the route planning unit 115 performs the route search. By the route search, the waypoints to be passed through and the passing order are specified. Then, the communication unit 140 transmits the ID information or the position of the waypoint to be passed through to the robot 200.

The area setting unit 121 divides the map into a plurality of areas. The area setting unit 121 sets a restricted area and a non-restricted area based on the plurality of areas. The area setting unit 121 sets the restricted area on the map. The restricted area is a region in which the movement of the robot 200 is restricted. For example, the restricted area is a region including an intersection or a branch point. Alternatively, a narrow passage through which the robot 200 cannot pass in both directions is a restricted area. In order for the robot 200 to pass through the restricted area, a right of way is needed. That is, the robot 200 to which the right of way is not granted cannot enter the restricted area and waits in front of the restricted area. The region other than the restricted area on the map is a non-restricted area. In the non-restricted area, the robot 200 can pass without the right of way. The area setting unit 121 sets one or a plurality of restricted areas on the map. In addition, the area setting unit 121 sets one or a plurality of non-restricted areas on the map.

The area setting unit 121 assigns an area ID to each of the restricted area and the non-restricted area. The area setting unit 121 stores the boundary line or the boundary coordinates in association with the area ID as the area information. The area information may include information indicating an attribute of the restricted area and the non-restricted area. For example, the attributes include a passage, an intersection, a branch point, an elevator hall, a hall, a room, an entrance and exit, a place to receive a package, a loading place, an unloading place, a waiting place, and a charging place. In addition, the area information may include information indicating the number of robots that can pass at the same time, and the like. The restriction on the passage is not limited to the prohibition of simultaneous passage, and may be one-way passage, one-side passage, or the like. In addition, the area setting unit 121 may change the area setting depending on a time slot or a situation.

For example, the area setting unit 121 divides each room into different areas. Then, the area setting unit 121 determines whether to set the area as the restricted area depending on the use, the size, the disposition, the layout, and the like of each room. The area setting unit 121 sets an intersection, a branch point, or the like of the passage as the restricted area. The area setting unit 121 sets a portion other than the intersection, the branch point, and the like as the non-restricted area. For example, the area setting unit 121 sets a straight portion of the passage as the non-restricted area.

As described above, the restricted area may be divided into a plurality of areas depending on the range or the content to be restricted. That is, the restricted area may be divided into sub-areas according to the degree of the passage restriction. For example, the restricted area may be divided into a simultaneous passage prohibition area, a one-side passage area, a one-way passage area, an entry prohibition area, a stop prohibition area, and the number of entering robots limit area. The simultaneous passage prohibition area is an area in which two or more robots cannot pass at the same time. The simultaneous passage prohibition area is an intersection, a branch point, or the like. The one-side passage area is, for example, an area in which the passage of the robot 200 is limited to one side in the passage. The one-way passage area is, for example, an area in which the passage of the robot 200 is limited to a specific direction in the passage. The one-side passage area or the one-way passage area is a passage having a narrow passage width, or the like. In the one-side passage area or the one-way passage area, two or more robots performing autonomous driving in the same direction can enter. On the other hand, in a case where there is a robot performing autonomous driving in a direction in the one-side passage area, the robot 200 performing autonomous driving in the opposite direction cannot enter the one-side passage area. In the one-way passage area, a robot performing autonomous driving in a specific direction can solely enter, but a robot proceeding in the opposite direction cannot enter.

The entry prohibition area is an area in which the robot cannot enter. The stop prohibition area is an area in which the robot cannot stop. The number of entering robots limit area is an area in which the number of robots that can enter is limited. For example, an elevator hall, a hall, a room, an entrance and exit, a place to receive a package, a loading place, an unloading place, a waiting place, a charging place, or the like can be the number of entering robots limit area or a simultaneous passage prohibition area. The area setting unit 121 may store information indicating whether the area is any one of the simultaneous passage prohibition area, the one-side passage area, the one-way passage area, the entry prohibition area, the stop prohibition area, or the number of entering robots limit area as the area information. As described above, the restricted area is divided into a plurality of sub-areas according to the restriction.

The control device 100 or another computer may set the restricted area and the non-restricted area by calculation processing, or the user may set the restricted area, the non-restricted area, and the like. Further, after the restricted area or the non-restricted area is set by the calculation processing, the user may manually adjust the area setting. For example, one or more restricted areas or one or more non-restricted areas may be set by executing a program by a computer such as the control device 100. The user may manually set one or more restricted areas or one or more non-restricted areas.

In addition, the control device 100 or another computer may divide the restricted area into the above-described sub-areas. Of course, there may be a sub-area other than the restriction shown in the above-described sub-areas. Alternatively, one or more of the above-described sub-areas may not be set. After the restricted area or the sub-area is set by the calculation processing, the user may manually adjust the sub-area setting. For example, one or more sub-areas may be set by executing a program by the computer such as the control device 100. The user may manually set one or more sub-areas.

By using a program for performing the area setting, the area setting can be easily performed. Specifically, the computer classifies the passage or the room based on the architectural drawing data, the map layout, and the BIM data. In a case where the computer specifies an intersection, a branch point, an entrance and exit, a waiting place, a corner, a narrow passage, or the like, the computer sets the place as the restricted area or the like. An artificial intelligence (AI) model generated by supervised learning or the like can be used for the automatic setting of the area.

Image data indicating the architectural drawing or BIM data is input to a machine learning model. The machine learning model specifies a place where passage is not possible, such as a wall or an installation, by a segmentation algorithm, and classifies the room or the passage. The machine learning model determines whether to restrict the passage, and sets the restricted area. For example, the machine learning model sets a narrow passage, an entrance and exit, a waiting place, a branch point, and the periphery thereof as the restricted area. The machine learning model sets an area other than the restricted area on the map as the non-restricted area.

Of course, the area setting unit 121 may perform the area setting using an algorithm other than the model obtained by the machine learning. Alternatively, the autonomous driving of the robot may be monitored after the operation of the robot. In a case where a place where the robot is likely to be unable to pass is specified, the area setting unit 121 may set the place as the restricted area. In addition, the setting may be performed by combining the manual setting and the automatic setting. The area setting unit 121 may divide the map into a plurality of areas by Voronoi division.

The waypoint setting unit 122 sets the waypoints on the map. The waypoints are points through which the robot 200 passes. The waypoints are used for the route planning. For example, the route planning unit 115 sets the waypoints from the departure point to the destination and the order thereof. The route planning unit 115 determines the order of the waypoints that are the passing points. The robot 200 performs autonomous driving to pass through the waypoints in the set order. For example, in a case where the passage branches at a branch point or an intersection, the waypoint setting unit 122 appropriately sets the waypoints at the branch point, the intersection, the corner, and the periphery thereof. In addition, the waypoint setting unit 122 sets the waypoints at a boundary portion of the area.

The waypoint setting unit 122 sets a plurality of waypoints on the map. The waypoint setting unit 122 assigns a waypoint ID to each waypoint. The waypoint setting unit 122 stores the coordinates and the ID of the waypoint in association with each other as the waypoint information. The waypoint information may include an attribute of the waypoint. In addition, the waypoint setting unit 122 may set a charger, the inside of an elevator, an elevator boarding and alighting position, a place to receive a package, a place to mount a package, and a front of an automatic door as the waypoints.

The control device 100 or another computer may set the waypoint by calculation processing, or the user may set the waypoint. Further, after the waypoint is set by the calculation processing, the user may manually adjust the waypoint setting. For example, one or more waypoints may be set by executing a program by a computer such as the control device 100. The user may manually set the waypoint.

By using a program for performing the waypoint setting, the waypoint setting can be easily performed. Specifically, in a case where the computer specifies an intersection or the like based on the architectural drawing data, the map layout, the CAD data, and the BIM data, the waypoint setting unit 122 sets the waypoint at the place. Alternatively, the waypoint setting unit 122 sets the waypoints at the boundary portion between the restricted area and the non-restricted area. An AI model generated by supervised learning or the like can be used for the automatic setting of the waypoint.

Image data indicating the architectural drawing or BIM data is input to a machine learning model. Further, the map data in which the area is set is input to the machine learning model. The machine learning model sets the waypoint by a segmentation algorithm. In addition, the setting may be performed by combining the manual setting and the automatic setting.

Further, the control device 100 includes a robot controller 125. The robot controller 125 controls a plurality of types of robots 200. The robot controller 125 performs control such that the robot 200 passes through the waypoints in the passing order set in the route search. As described above, the route planning unit 115 searches for a route to the destination based on the plurality of waypoints. As a result, the waypoint to be passed through is selected from among the plurality of waypoints registered on the map. Further, the route planning unit 115 determines the passing order of the selected waypoints. The robot is controlled such that the robot 200 sequentially passes through the waypoints to the destination. In addition, the robot controller 125 may control the entry of the robot 200 into the restricted area based on the right of way.

Further, in the present embodiment, the waypoint setting unit 122 sets the passage classification of the robot for the waypoint. For example, the passage classification such as bidirectional passage permission, simultaneous passage permission, simultaneous passage prohibition, one-way passage, one-side passage, entry prohibition, and number of entering robots limit is associated with the waypoint. The waypoint setting unit 122 stores information such as the ID, the coordinate, and the passage classification of the waypoint as the waypoint information in a memory or the like. The passage classification is in accordance with the area information. For example, in the restricted area including the waypoint, the passage classification for restricting the passage is assigned. That is, the passage classification is in accordance with the restriction of the sub-area. In addition, for the waypoint of the non-restricted area, a passage classification such as bidirectional passage permission or simultaneous passage permission may be set. The waypoint in a wide passage or the like has a passage classification that allows bidirectional passage. In addition, the waypoint in a sufficiently wide room or the like has a passage classification that allows simultaneous passage.

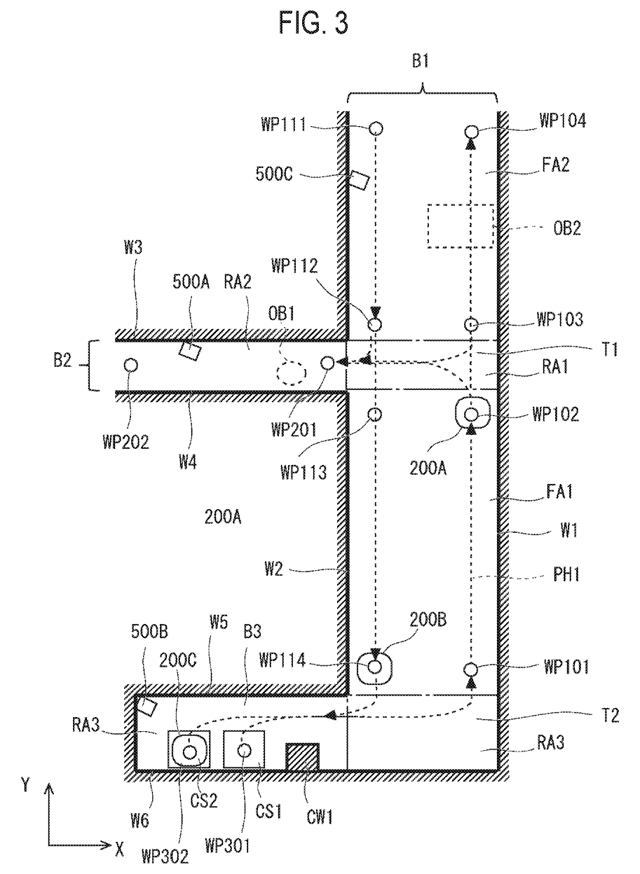

The restricted area, the non-restricted area, and the waypoint set on the map will be described with reference to FIG. 3. FIG. 3 is a plan view schematically showing the map. In FIG. 3, an XY two-dimensional orthogonal coordinate system is shown for clarity of description. In FIG. 3, three robots 200 are shown, and these are identified as robots 200A, 200B, 200C. In addition, in a case where the robots 200A, 200B, 200C are not identified, they will be collectively referred to as robot 200.

In FIG. 3, a passage B1 is provided along the Y direction. A wall on the +X side defining the passage B1 is a wall W1, and a wall on the -X side is a wall W2. That is, the passage B1 is between the walls W1, W2 shown in the map. In the XY plan view, the walls W1, W2 are straight lines along the Y direction. A branch point T1 that is a three-way junction is provided in the middle of the passage B1. A passage B2 extending in the X direction is connected to the branch point T1. That is, the branch point T1 corresponds to an intersection where the passages B1, B2 intersect. The passage B2 extends from the branch point T1 in the -X direction.

Here, the robot 200 will be described as performing autonomous driving on the right side of the passage. Therefore, the robot 200A that proceeds in the +Y direction on the passage B1 performs autonomous driving on the wall W1 side of the passage B1. In addition, the robot 200B that proceeds in the -Y direction on the passage B1 performs autonomous driving on the wall W2 side of the passage B1. Of course, the robot 200 may be set to proceed on the left side of the passage.

The branch point T1 where the passages B1, B2 intersect is a restricted area RA1. The restricted area RA1 is a simultaneous passage restricted area. That is, the restricted area RA1 is an area in which two or more robots 200 cannot enter at the same time. In the passage B1, a -Y side of the restricted area RA1 is a non-restricted area FA1, and a +Y side is a non-restricted area FA2. That is, in the Y direction, the restricted area RA1 is disposed between the non-restricted areas FA1, FA2.

A wall on a +Y side defining the passage B2 is a wall W3, and a wall on a -Y side is a wall W4. The passage B2 has a passage width that does not allow the robots to pass each other. An interval between the walls W3, W4 in the Y direction is narrower than an interval between the walls W1, W2 in the X direction. Since the passage B2 is a narrow passage, the robots 200 cannot pass each other in the passage B2. Therefore, the passage B2 is a restricted area RA2. Specifically, the restricted area RA2 corresponding to the passage B2 is a one-way passage area. In the passage B2, the autonomous driving direction of the robot 200 is limited to the -X direction. On the contrary, the robot 200 cannot perform autonomous driving on the passage B2 in the +X direction. Since the passage B1 has a sufficient passage width, the robots 200 can pass each other. Therefore, a portion of the passage B1 other than the branch point T1 is the non-restricted areas FA1, FA2.

Further, a corner T2 is provided at the end of the passage B1 on the -Y side. The end of the passage B1 on the -Y side is a corner T2 that curves to the -X side. A waiting area B3 is provided in front of the corner T2. The waiting area B3 is on the -X side of the passage B1. The back of the waiting area B3 is a dead end. The waiting area B3 includes two charging points CS1, CS2. A charger is installed at each of the charging points CS1, CS2. For example, the battery mounted on the robot 200C is charged when the robot 200C stops at the charging point CS2. The waiting area B3 is a charging place where two robots can be charged at the same time. In addition, the robot 200 waits in the waiting area B3 for charging. The robot 200B that proceeds on the passage B1 in the -Y direction turns right, and the robot 200B performs autonomous driving toward the charging point CS1 or the charging point CS2. Of course, the number of charging points is not particularly limited as long as it is one or more.

Here, the corner T2 and the waiting area B3 are a restricted area RA3. Specifically, the restricted area RA3 is a one-side passage area. For example, a wall on a +Y side of the waiting area B3 is a wall W5, and a wall on a -Y side is a wall W6. A column CW1 is provided on the wall W6. The column CW1 is disposed between the corner T2 and the waiting area B3. Since the interval between the wall W5 and the column CW1 is narrow, the robots 200 cannot pass each other. Therefore, the waiting area B3 and the corner T2 are the restricted area RA3.

The restricted area RA3 is divided into a one-side passage area. For example, while the robot 200 moving from the waiting area B3 toward the passage B1 performs autonomous driving in the restricted area RA3, the passage of the robot 200 moving from the passage B1 toward the waiting area B3 is restricted. Specifically, in a case where the charging at the charging point CS2 is completed, the robot 200C moves in the restricted area RA3 to return to the passage B1. In a case where the robot 200C that is returning to the passage B1 is present, the robot 200B that is moving to the charging point CS1 or the charging point CS2 for charging cannot enter the restricted area RA3. The robot 200B waits in front of the corner T2.

On the contrary, in a case where the robot 200 (not shown) moving from the passage B1 toward the waiting area B3 performs autonomous driving in the restricted area RA3, the passage of the robot 200 moving from the waiting area B3 toward the passage B1 is restricted. Specifically, while the robot 200 moves in the restricted area RA3 toward the charging point CS1 or the charging point CS2, the passage of the robot 200C moving from the charging point CS2 toward the passage B1 is restricted. That is, the robot 200C remains waiting at the charging point CS2.

In the passage B1, the waypoints WP101 to WP104 and the waypoints WP111 to WP114 are set for the robot 200. The waypoints WP101 to WP104 are passing points in a case where the robot 200A proceeds in the +Y direction on the passage B1. The waypoints WP101 to WP104 are disposed on a straight line parallel to the Y direction. The route PH1 is a straight line passing through the waypoints WP101 to WP104. In a case where the robot 200A performs autonomous driving on the passage B1 in the +Y direction, the robot 200A sequentially passes through the waypoints WP101, WP102, WP103, WP104. The waypoints WP111 to WP114 are passing points in a case where the robot 200 proceeds in the -Y direction on the passage B1. The waypoints WP111 to WP114 are disposed on a straight line parallel to the Y direction. In a case where the robot 200 performs autonomous driving on the passage B1 in the -Y direction, the robot 200 sequentially passes through the waypoints WP111, WP112, WP113, WP114.

Here, the waypoint WP102 is set on the non-restricted area FA1 side of the boundary between the restricted area RA1 and the non-restricted area FA1. Therefore, in a case where another robot 200 is in the restricted area RA1, the robot 200A waits at the waypoint WP102. That is, after the other robot 200 exits from the restricted area RA1, the robot 200A departs from the waypoint WP102 and enters the restricted area RA1. Similarly, the waypoint WP112 is set on the non-restricted area FA2 side of the boundary between the restricted area RA1 and the non-restricted area FA2. In a case where another robot 200 is in the restricted area RA1, the robot 200 waits at the waypoint WP112.

As a result, the robot 200 can efficiently perform autonomous driving in the restricted area RA1 in which the robot 200 can perform autonomous driving in various directions. In the intersection, the corner, or the like, the robot 200 moves straight ahead or turns right or left, and thus it is assumed that the robot 200 performs autonomous driving in various directions. Therefore, the intersection is the restricted area RA1 in which the free entry of the robot 200 is restricted. As a result, the number of robots 200 that are present in the restricted area RA1 at the same time can be limited.

The area setting unit 121 sets the intersection or the branch point as the restricted area. Then, the robot 200 to which the right of way is granted by the right-of-way granting unit 123 shown in FIG. 2 can solely enter the restricted area RA1. In other words, in a case where the robot 200 is already in the restricted area RA1, the other robot 200 can enter the restricted area RA1 after the robot 200 in the restricted area RA1 leaves the restricted area RA1. Therefore, the waypoints WP102, WP112 at the boundary portion are waiting positions where the robot 200 waits.

The waypoints WP201, WP202 are set in the passage B2. The passage B2 is one-way passage. The robot 200 can perform autonomous driving on the passage B2 solely in the -X direction, and cannot perform autonomous driving on the passage B2 in the +X direction. A camera 500A is installed in the passage B2.

The waypoints WP301, WP302 are set in the waiting area B3. The waypoints WP301, WP302 correspond to the charging points CS1, CS2. A camera 500B is installed in the waiting area B3. In addition, the camera 500B may be mounted on the robot 200.

A camera 500C is set in the passage B1. The camera 500C captures an image of the non-restricted area FA2. The cameras 500A, 500B, 500C capture an image of the environment in which the robot 200 moves. The cameras 500A, 500B, 500C may be a security camera or a surveillance camera installed on a wall surface or a ceiling. In addition, the cameras 500A, 500B, 500C may be mounted on the robot 200.

The area setting unit 121 sets the intersection, the branch point, the waiting place, the narrow passage, or the like as the restricted area. Then, the robot 200 to which the right of way is granted by the right-of-way granting unit 123 shown in FIG. 2 can solely enter the restricted area RA1. In other words, in a case where the robot 200 is already in the restricted area RA1, the other robot 200 can enter the restricted area RA1 after the robot 200 in the restricted area RA1 leaves the restricted area RA1. Therefore, the waypoints WP102, WP112 at the boundary portion are waiting positions where the robot 200 waits.

The right-of-way granting unit 123 shown in FIG. 2 grants the right of way to the robot 200. The right of way is a resource that allows the robot 200 to pass through the restricted area RA1. The right-of-way granting unit 123 grants the right of way for each robot. Further, the right-of-way granting unit 123 manages the right of way for each restricted area. The right-of-way granting unit 123 grants the right of way based on the current position of each robot 200.

The right-of-way granting unit 123 grants the right of way to the robot 200 in response to a request from the robot 200. For example, a case where the robot 200 at the waypoint WP102 moves to the waypoint WP201 will be described. In a case where the robot 200 arrives at the waypoint WP102 or the vicinity thereof, the robot 200 transmits a request signal for requesting the right of way of the restricted area RA1 to the control device 100. In a case where the communication unit 140 of the control device 100 receives the request signal, the right-of-way granting unit 123 grants the right of way of the restricted area RA1 to the robot 200. Specifically, the communication unit 140 transmits the right-of-way granting signal to the robot 200. The right-of-way granting signal includes an area ID or the like of the restricted area where passage is permitted. Alternatively, the right-of-way granting unit 123 may determine whether to grant the right of way. Further, the right-of-way granting unit 123 may manage the order of the robots permitted to pass. For example, the right-of-way granting unit 123 may define the passing order in the order of the request from the robot 200.

The control device 100 includes a robot controller 125. The robot controller 125 controls a plurality of robots 200. The robot controller 125 performs control such that the robot 200 passes through the waypoints in the passing order set in the route search. As described above, the route planning unit 115 searches for a route to the destination based on the plurality of waypoints. As a result, the waypoint to be passed through is selected from among the plurality of waypoints registered on the map. Further, the route planning unit 115 determines the passing order of the selected waypoints. The robot is controlled such that the robot 200 sequentially passes through the waypoints to the destination. In addition, the robot controller 125 may control the entry of the robot 200 into the restricted area based on the right of way.

The restricted areas RA1 to RA3 can also be referred to as a right-of-way management region that allows passage by granting the right of way. That is, the robot 200 to which the right of way is not granted cannot enter the simultaneous passage prohibition area, the one-side passage area, the one-way passage area, the entry prohibition area, the stop prohibition area, the number of entering robots limit area, or the like. The non-restricted area can also be referred to as a non-right-of-way management region in which the robot 200 can freely enter even without the right of way being granted. The non-restricted areas FA1, FA2 in the passage B1 allow bidirectional passage.

Further, the passage classification change unit 127 changes the passage classification set for the waypoint based on the captur ed result of the camera. For example, it is assumed that the passage classifications of the waypoints WP201, WP202 included in the restricted area RA2 that is one-way passage are set to one-way passage. Here, the camera 500A captures an image of the restricted area RA2. The passage classification change unit 127 changes the passage classifications of the waypoints WP201, WP202 based on the captured result of the camera 500A.

For example, it is assumed that there is an obstacle OB1 in the passage B2. The camera 500A captures an image of the obstacle OB1 in the passage B2. The passage classification change unit 127 detects the obstacle OB1 based on the captured result of the camera 500A. Then, the passage classification change unit 127 changes the passage classifications of the waypoints WP201, WP202 in the restricted area RA2 in which the obstacle OB1 is detected. Specifically, the passage classification change unit 127 changes the passage classification from one-way passage to entry prohibition. In a case where there is an obstacle in the restricted area RA2 that is the narrow passage, the robot 200 cannot pass through the passage B2. In this case, the passage classification change unit 127 changes the passage classifications of the waypoints WP201, WP202 to the entry prohibition. Therefore, the robot 200A at the waypoint WP102 cannot enter the passage B2 by turning left. In this case, the robot 200A changes the route to move straight ahead toward the waypoint WP103.

In addition, as another example, it is assumed that there is an obstacle OB2 in the restricted area RA2. The camera 500C captures an image of the obstacle OB2 in the passage B2. The passage classification change unit 127 detects the obstacle OB2 based on the captured result of the camera 500A. The passage classification change unit 127 changes the passage classifications of the waypoints WP103, WP104 in the restricted area RA2 in which the obstacle OB2 is detected. Specifically, the passage classification change unit 127 changes the passage classification from simultaneous passage permission to one-way passage. Therefore, the non-restricted area FA2 is one-way passage in which the robot 200 can pass solely in the +Y direction. Therefore, the robot 200A at the waypoint WP102 cannot enter the non-restricted area FA2 by moving straight ahead. In this case, the robot 200A changes the route to turn left toward the waypoint WP201.

In addition, the passage classification change unit 127 may detect the position coordinate of the obstacle on the map. The passage classification change unit 127 may change the passage classification based on the position coordinate of the obstacle. For example, the obstacle OB2 is between the waypoints WP103, WP104. Therefore, the passage classification change unit 127 sets the passage classification to one-way passage in the +Y direction such that the robot 200A can proceed in the -Y direction and cannot proceed in the +Y direction.

In this way, the passage classification change unit 127 temporarily changes the passage classification based on the captured result of the camera 500. In the area in which the obstacle is detected, the passage classification of the waypoint is changed such that the passage restriction indicated by the passage classification is strict. In this way, the robot 200 can move while avoiding the region in which the obstacle is detected. Then, in a case where it is detected that the obstacle has been removed, the passage classification change unit 127 restores the passage classification to the original classification.

For example, it is assumed that the waypoints WP103, WP104 in the non-restricted area FA2 have a passage classification of non-right-of-way management. In this case, in a case where the obstacle is detected, the passage classifications of the waypoints WP103, WP104 are changed from the non-right-of-way management to the one-way passage or the right-of-way management. In addition, in a case where the obstacle is detected, the route planning unit 115 may re-search the route. Then, the communication unit 140 of the control device 100 transmits the route information corresponding to the re-searched route to the robot 200. As a result, the plurality of robots can move efficiently. In a case where it is detected that the obstacle has been removed, the passage classification change unit 127 restores the passage classification to the non-right-of-way management.

Further, the passage classification change unit 127 may determine a situation of the environment in which the robot 200 moves. For example, the passage classification change unit 127 determines a congestion status of at least a part of the area based on the captured result. In a case where the area is congested, the passage classification change unit 127 changes the passage classification of the waypoint included in the area. For example, in a case where the passage classification of the waypoint before the congestion is a first passage classification, the passage classification after the congestion is a second passage classification that has stricter restrictions than the first passage classification. In a case where the area is congested, the passage classification change unit 127 changes the passage classification to the second passage classification in a case where the passage is congested. The second passage classification has stricter restrictions than the first passage classification. For example, the passage classification change unit 127 changes the bidirectional passage to the one-side passage or the one-way passage. Alternatively, the passage classification change unit 127 changes the passage classification by reducing the allowable number of entering robots that are limited to the number of entering robots.

Further, the passage classification change unit 127 may detect that the congestion is resolved based on the captured result. In a case where it is detected that the congestion has been resolved, the passage classification change unit 127 changes the passage classification to be relaxed. For example, in a case where it is detected that the congestion has been resolved, the passage classification change unit 127 restores the passage classification from the second passage classification to the first passage classification. In this way, the robot 200 can move while avoiding the congested area. Therefore, the robot 200 can move efficiently.

In addition, the passage classification change unit 127 may determine a congestion status in the waiting area based on the captured result of the camera. In a case where the waiting area is congested, the passage classification change unit 127 may change the passage classification such that the entry to the waiting region is restricted. An example of this will be described.

As described above, there are two charging points CS1, CS2 in the waiting area B3. It is assumed that the robot 200 is present at each of the two charging points CS1, CS2. That is, it is assumed that the robot 200C and another robot 200 are being charged at the charging points CS1, CS2. In a case where the two robots 200 are being charged at the charging points CS1, CS2, there is no vacancy at the charging point. Therefore, the passage classification change unit 127 determines that the waiting area B3 is congested. In this case, the passage classification change unit 127 changes the passage classifications of the waypoints WP301, WP302 such that the entry to the waiting area B3 is restricted.

For example, it is assumed that the passage classifications of the waypoints WP301, WP302 are one-side passage before the congestion. The passage classification change unit 127 detects that the robot 200 is present at each of the two charging points CS1, CS2 based on the captured image of the camera 500C. Therefore, the passage classification change unit 127 determines that the waiting area B3 is congested. Then, the passage classifications of the waypoints WP301, WP302 are changed from the one-side passage to the one-way passage or the entry prohibition. As a result, the other robot 200 is restricted from entering the waiting area B3 from the passage B1. For example, the robot 200B at the waypoint WP114 waits at the waypoint WP114. The robot 200B at the waypoint WP114 searches for a route to the other charging point. Whether the robot 200B waits or moves to the other charging point may be determined according to the remaining charging time.

In a case where the robot 200 moves from one of the charging points CS1, CS2, the passage classification change unit 127 restores the passage classifications of the waypoints WP301, WP302 to the original classifications. As a result, the passage classifications of the waypoints WP301, WP302 are changed to the one-side passage. In a case where the robot 200, having completed charging, enters the passage B1 from the restricted area RA3, the robot 200B moves from the waypoint WP114 to the charging point CS1 or the charging point CS2. That is, the robot 200B is granted the right of way and can move in the restricted area RA3. In this way, the plurality of robots 200 can move efficiently. Further, the plurality of robots 200 can be efficiently charged.

In the above example, the area including the charging points CS1, CS2 is shown as the waiting area B3, but the waiting area B3 may be an area other than the charging area. For example, an area including an elevator hall, a hall, a room, an entrance and exit, a place to receive a package, a loading place, and an unloading place can be used as the waiting area.

The control device 100 or the robot 200 may use a machine learning model such as deep learning in the route planning or the driving control. Further, in the detection of the peripheral object or the like, a machine learning model such as deep learning such as a recurrent neural network (RNN) or a convolutional neural network (CNN) may be used.

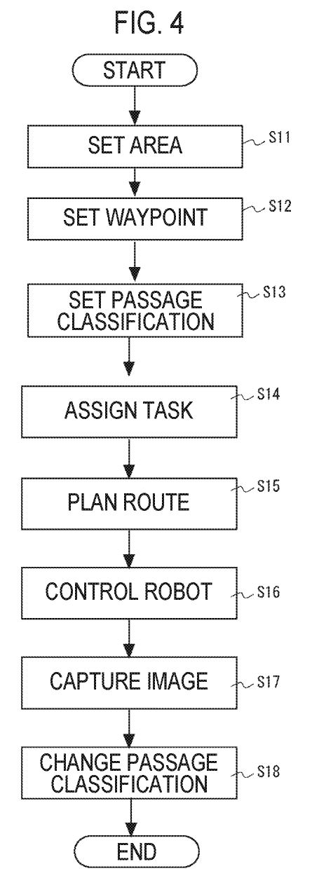

A control method by the control system according to the present embodiment will be described with reference to FIG. 4. FIG. 4 is a flowchart showing a robot control method according to the present embodiment. First, the area setting unit 121 sets the area on the map (S11). As a result, the map is divided into the restricted area and the non-restricted area. The restricted area or the non-restricted area is divided into the sub-areas.

The waypoint setting unit 122 sets a plurality of waypoints (S12). Here, the waypoint setting unit 122 sets the waypoints in the restricted area and the non-restricted area. Further, the waypoint group that is available is registered based on the robot information, the transport object information, and the task information. That is, the position of the waypoint is set to be different depending on the robot or the like.

The waypoint setting unit 122 sets the passage classification for each waypoint (S13). Here, the passage classification corresponding to the area to which the waypoint belongs is set.

The task management unit 114 assigns the task to the robot (S14). For example, in a case where the user registers the task to be executed, the task management unit 114 determines the robot that executes the task based on the availability of the robot, the current position, and the like.

Next, the route planning unit 115 performs the route planning (S15). For example, the route planning unit 115 acquires the current position of the robot that executes the task from the robot information storage unit 112. The route planning unit 115 searches for a route from the current position to the via point or the destination. For example, the route planning unit 115 acquires the type of the robot from the robot information. As a result, the waypoint to be passed is determined from among the plurality of waypoints. Further, the route planning unit 115 determines the passing order of the waypoints.

The robot controller 125 controls the robot 200 such that the robot 200 passes through the waypoints in the set passing order (S16). The robot controller 125 controls the robot 200 such that the robot 200 sequentially passes through the waypoints to the destination. The control here may include processing such as the right-of-way granting. As a result, the robot can be appropriately controlled, and thus the task can be efficiently executed.

The camera 500 captures an image of the environment in which the robot 200 moves (S17). The passage classification change unit 127 changes the passage classification of the waypoint based on the captured result (S18). For example, in a case where the obstacle is detected, the passage classification change unit 127 changes the passage classification of the waypoint included in the area. The passage classification change unit 127 changes the passage classification of the waypoint to be stricter. Alternatively, the passage classification change unit 127 may determine the congestion status of the area. The passage classification change unit 127 changes the passage classification according to the congestion status. As a result, the passage of the robot 200 to the area with the obstacle or the congested area is restricted. That is, the robot moves to avoid the area with the obstacle or the congested area. As a result, the plurality of robots 200 can move efficiently. In addition, in a case where the passage classification change unit 127 changes the passage classification of the waypoint, the route planning unit 115 may re-search the route for the robot 200 scheduled to pass through the waypoint.

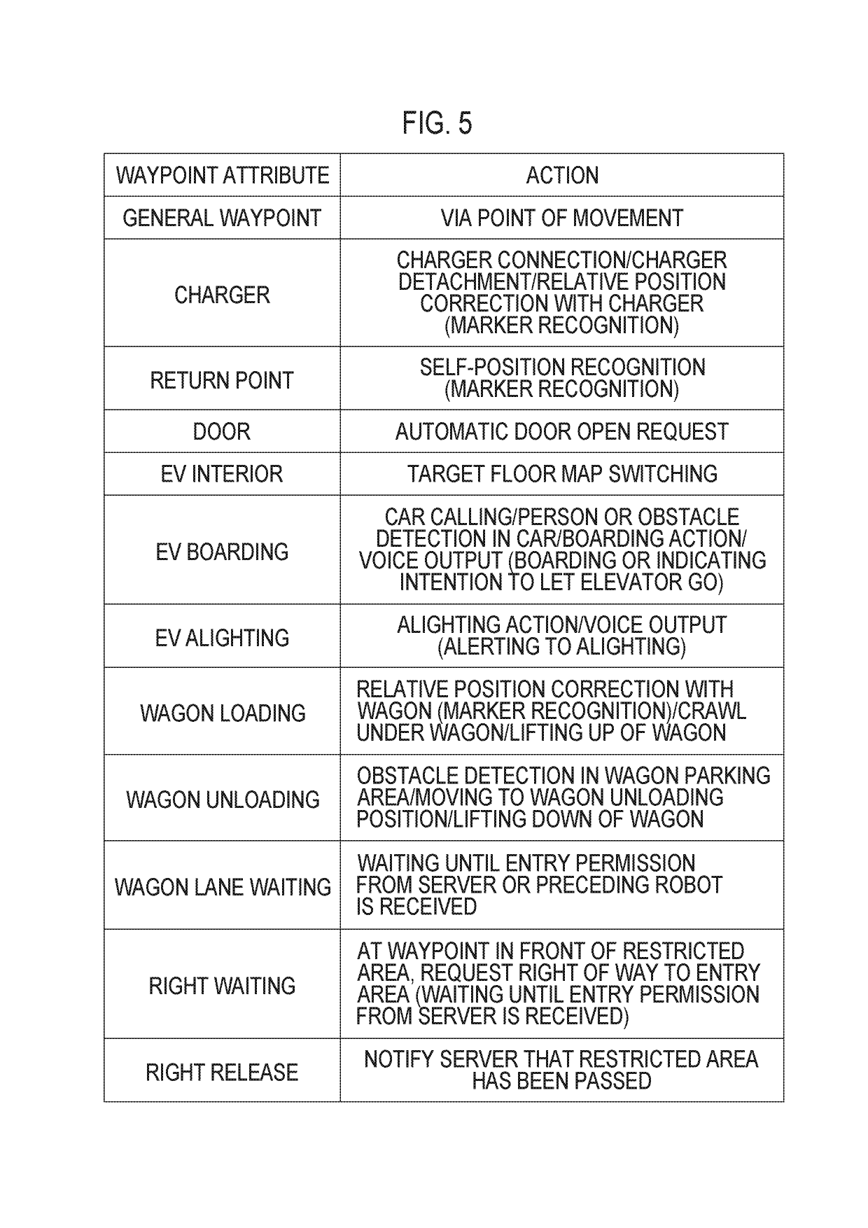

Further, the waypoint setting unit 122 may assign an attribute or an action to the waypoint. FIG. 5 is a table showing the attribute of the waypoint and the action associated with the attribute. In FIG. 5, a general waypoint, a charger, a return point, a door, an EV interior, EV boarding, EV alighting, a wagon loading, a wagon unloading, a wagon lane waiting, a right waiting, and a right release are registered as the waypoint attributes. It should be noted that two or more attributes may be assigned to one waypoint. Specifically, one or more other attributes may be assigned in addition to the general waypoint attribute.

The general waypoint has a role as a via point of the movement in the route planning. The robot 200 autonomously moves toward the next waypoint by passing through the general waypoint. The charger indicates a place where the charger of the robot 200 is installed. In a case where the battery remaining amount is equal to or less than a certain value, the robot 200 moves to the waypoint of the charger as the destination. In a case where the robot 200 arrives at the waypoint of the charger, the robot 200 performs relative position correction. For example, a marker is attached to the charger, and the camera of the robot 200 captures an image of the marker to perform the relative position correction. Then, the robot 200 is connected to the charger to perform the charging. In a case where the charging is completed, the robot 200 performs the charger detachment.

The return point corresponds to a position where a marker for self-position recognition is provided. For example, a marker is installed on a wall or the like, and the robot 200 that has arrived at the waypoint of the return point captures an image of the marker with the camera. Then, the robot 200 obtains the relative position of the robot with respect to the marker based on the captured image of the marker. Since the marker position on the map is known, the self-position is estimated from the relative position of the robot 200 with respect to the marker. In this way, the estimation error of the self-position accumulated in the odometry can be corrected.

The door corresponds to a position where the robot 200 transmits a signal for requesting opening of the automatic door. Alternatively, the door corresponds to a position where the robot 200 waits until the automatic door is opened. The EV interior corresponds to a position in the elevator car, and is a position where the robot 200 stops while the elevator is moving up and down. The robot 200 switches the floor map to the destination floor at this position.

The EV boarding corresponds to the elevator boarding and alighting position. That is, it corresponds to a position where the elevator is waiting. In a case where the robot 200 arrives at the waypoint of the EV boarding, the car is called, and a person or an obstacle in the car is detected. In a case where there is a vacancy in the elevator car, the robot 200 performs a boarding action. In a case where there is no vacancy in the elevator car, the robot 200 outputs a voice to indicate an intention to let the elevator go. The EV alighting corresponds to the elevator boarding and alighting position. That is, in a case where the robot 200 arrives at the waypoint of the EV alighting, the robot 200 performs the alighting after giving an alert to the person nearby by voice.

The wagon loading corresponds to a place where the robot loads the wagon as the accessory unit 700 shown in FIG. 1. In a case where the robot 200 arrives near the waypoint of the wagon loading, the robot 200 captures an image of the marker provided on the wagon with the camera. Then, the robot 200 performs the relative position correction with the wagon based on the captured image of the marker. Then, after the relative position correction, the robot 200 crawls under the wagon and lifts up the wagon.

The wagon unloading corresponds to a place where the robot unloads the wagon as the accessory unit 700 shown in FIG. 1. In a case where the robot 200 arrives near the waypoint of the wagon unloading, the robot 200 uses the sensor to detect whether there is an obstacle at the place where the wagon is unloaded. In a case where there is no obstacle, the robot moves to the unloading position and lifts down the wagon.

The wagon lane corresponds to a place where a plurality of wagons is arranged. The waypoint of the wagon lane is included in, for example, a restricted area in which the number of robots that can enter is determined. The robot 200 waits until the entry permission from the server that is the control device 100 or the robot 200 that precedes is received.

The right waiting corresponds to a boundary portion between the restricted area and the non-restricted area. The right waiting waypoint is installed in front of the restricted area. In a case where the robot 200 arrives at the right waiting waypoint, the robot 200 requests the right of way from the control device 100.

The right release corresponds to a boundary portion between the restricted area and the non-restricted area. The right release waypoint is installed in, for example, the non-restricted area. In a case where the robot 200 arrives at the right release waypoint, the robot 200 notifies the server that is the control device 100 that the robot 200 has passed. Of course, the attribute of the waypoint is not limited to the above examples. Some of the above may not be provided, and other waypoints may be provided.

In addition, a part or all of the processing in the robot 200, the control device 100, and the like described above can be realized as a computer program. Such a program can be stored in various types of non-transitory computer readable media and supplied to the computer. The non-transitory computer readable medium includes various types of tangible recording media. Examples of the non-transitory computer readable medium include a magnetic recording medium (for example, a flexible disk, a magnetic tape, and a hard disk drive), a magneto-optical recording medium (for example, a magneto-optical disk), a CD-read only memory (ROM), a CD-R, and a CD-R/W. Examples of the non-transitory computer readable medium further include a semiconductor memory (for example, a mask ROM, a programmable ROM (PROM), an erasable PROM (EPROM), a flash ROM, and a random access memory (RAM)). In addition, the program may be supplied to the computer by various types of transitory computer readable media. Examples of the transitory computer readable media include electrical signals, optical signals, and electromagnetic waves. The transitory computer readable medium can supply the program to the computer via a wired communication route such as an electric wire and an optical fiber, or a wireless communication route.

The present disclosure is not limited to the embodiment, and can be appropriately modified without departing from the spirit.

What is claimed is:

1. A robot control system that controls an autonomous movement robot, wherein the robot control system is configured to
set, on a map, a plurality of waypoints serving as candidates for via points of the autonomous movement robot,
set a passage classification of the autonomous movement robot to each of the waypoints,
search for a route to a destination based on the waypoints,
control the autonomous movement robot such that the autonomous movement robot sequentially passes through the waypoints to the destination in accordance with the passage classification,
capture an image of an environment in which the autonomous movement robot moves using a camera, and
change the passage classification based on a captured result of the camera.

2. The robot control system according to claim 1, wherein the robot control system is configured to
determine a congestion status of a partial area in the environment based on the captured result of the camera, and
change the passage classification of a waypoint included in the area from a first passage classification to a second passage classification that has a stricter restriction than the first passage classification when the area is congested.

3. The robot control system according to claim 1, wherein the robot control system is configured to
determine a congestion status in a waiting area of the autonomous movement robot based on the captured result of the camera, and
change the passage classification such that the autonomous movement robot is restricted from entering the waiting area when the waiting area is congested.

4. The robot control system according to claim 1, wherein the robot control system is configured to
detect whether an obstacle is present on a passage based on the captured result of the camera, and
set the passage classification to one-way passage or right-of-way management when the obstacle is detected.

5. A robot control method that controls a plurality of kinds of autonomous movement robots, the robot control method comprising:
setting, on a map, a plurality of waypoints serving as candidates for via points of the autonomous movement robots;
setting a passage classification of the autonomous movement robots to each of the waypoints;
searching for a route to a destination based on the waypoints;
controlling the autonomous movement robots such that the autonomous movement robots sequentially pass through the waypoints to the destination in accordance with the passage classification;
capturing an image of an environment in which the autonomous movement robots move using a camera; and
changing the passage classification based on a captured result of the camera.
